(19) United States
(12) Patent Application Publication
(10) Pub. No.: US 2023/0230754 A1
(43) Pub. Date: Jul. 20, 2023

(54) COIL COMPONENT

(71) Applicant: Murata Manufacturing Co., Ltd., Kyoto-fu (JP)

(72) Inventor: Takashi TOMOHIRO, Nagaokakyo-shi (JP)

(73) Assignee: Murata Manufacturing Co., Ltd., Kyoto-fu (JP)

(21) Appl. No.: 18/151,065

(22) Filed: Jan. 6, 2023

(30) Foreign Application Priority Data
Jan. 14, 2022 (JP) 2022-004580

(51) Int. Cl. H01F 27/29; H01F 17/00

(52) U.S. Cl. CPC H01F 27/292; H01F 17/0013

(57) ABSTRACT

A coil component having a low inductance and capable of coping with a large current by lowering DC resistance. A coil component includes a magnetic body, a coil in the magnetic body, an external electrode on at least a bottom surface of the magnetic body and electrically connected to the coil, and an extended conductor having one end connected to the coil inside the magnetic body and the other end connected to the external electrode on the bottom surface of the magnetic body. The external electrode includes first and second external electrodes. The extended conductor includes a first extended conductor having one end connected to a start end of the coil and the other end connected to the first external electrode, and a second extended conductor having one end connected to a terminal end of the coil and the other end connected to the second external electrode.

### CROSS-REFERENCE TO RELATED APPLICATION

This application claims benefit of priority to Japanese Patent Application No. 2022-004580, filed Jan. 14, 2022, the entire content of which is incorporated herein by reference.

### BACKGROUND

### Technical Field

The present disclosure relates to a coil component.

### Background Art

Japanese Patent Application Laid-Open No. 2021-57482 discloses a coil component including a substantially rectangular parallelepiped first magnetic body including a coil conductor, and a second magnetic body arranged on at least an upper surface of the first magnetic body, in which the first magnetic body includes first magnetic particles composed of a metal magnetic body, the second magnetic body includes second magnetic particles and a resin, and a content of the resin in the second magnetic body is larger than a content of the resin in the first magnetic body.

### SUMMARY

Conventional coil components are prepared by a sheet lamination method or a printing lamination method in which a magnetic filler such as ferrite powder or metal powder is mixed with a binder or the like to prepare a magnetic sheet or a magnetic paste, and then combined with screen printing of a conductive paste such as Ag paste as a coil. In the sheet lamination method, a coil pattern is printed and laminated on a magnetic sheet with a hole for coil connection made by laser, punching, or the like. On the other hand, in the printing lamination method, printing of a conductive paste for forming a coil pattern and printing of a magnetic paste for forming a magnetic pattern are overlapped. By the above method, a spiral coil is formed in the lamination direction. A desired inductance is acquired by the number of laminated layers.

In recent years, a coil component for a DC-DC converter mounted on an electronic device such as a smartphone or a personal computer is required to have a small size, a low height, a low inductance, and a large current performance as an operating frequency becomes higher. However, in a conventional structure in which a coil is wound over a plurality of layers, the inductance is relatively high and the DC resistance is also large, so that it is difficult to realize a high rated current.

In addition, mounting on the bottom surface of the coil component is increasingly required in order to cope with high-density mounting. In that case, both ends of a coil need to be extended to the bottom surface. However, since the routing of the coil becomes complicated, it is difficult to obtain desired performance.

Furthermore, in a portion where coil patterns overlap in the lamination direction, a short circuit may occur due to a defect between the upper and lower portions of the coil.

Accordingly, the present disclosure provides a coil component having a low inductance and capable of coping with a large current by reducing DC resistance.

A coil component of the present disclosure includes a magnetic body; a coil embedded in the magnetic body; an external electrode provided on at least a bottom surface of the magnetic body and electrically connected to the coil; and an extended conductor in which one end is connected to the coil inside the magnetic body and the other end is connected to the external electrode on the bottom surface of the magnetic body. The external electrode includes a first external electrode and a second external electrode. The extended conductor includes a first extended conductor having one end connected to a start end of the coil and the other end connected to the first external electrode, and a second extended conductor having one end connected to a terminal end of the coil and the other end connected to the second external electrode. The coil is present only on one plane including the start end and the terminal end, When a surface on which the coil is present is viewed from a direction extending from the one end to the other end of the first extended conductor, the coil and the first extended conductor do not overlap each other except for a portion where the coil and the first extended conductor are connected, and when the surface on which the coil is present is viewed from a direction extending from the one end to the other end of the second extended conductor, the coil and the second extended conductor do not overlap each other except for a portion where the coil and the second extended conductor are connected.

According to the present disclosure, it is possible to provide a coil component having a low inductance and capable of coping with a large current by reducing the DC resistance.

### BRIEF DESCRIPTION OF THE DRAWINGS

FIG. 1 is a perspective view schematically showing an example of a coil component of the present disclosure;

FIG. 2 is a perspective view schematically showing an example of an internal structure of the coil component shown in FIG. 1;

FIG. 3 is a sectional view of the coil component shown in FIG. 2 taken along line III-III;

FIG. 4A is a plan view schematically showing an example of a method for forming a magnetic paste layer;

FIG. 4B is a plan view schematically showing an example of a method for forming a conductive paste layer on a magnetic paste layer;

FIG. 4C is a plan view schematically showing an example of a method for forming a via conductor on a conductive paste layer;

FIG. 4D is a plan view schematically showing an example of a method for forming a conductive paste layer as a base layer of an external electrode;

FIG. 5 is a perspective view schematically showing a first modification of the internal structure of the coil component of the present disclosure;

FIG. 6 is a perspective view schematically showing a second modification of the internal structure of the coil component of the present disclosure;

FIG. 7 is a perspective view schematically showing a third modification of the internal structure of the coil component of the present disclosure;

FIG. 8 is a perspective view schematically showing a fourth modification of the internal structure of the coil component of the present disclosure;

FIG. 9 is a perspective view schematically showing a fifth modification of the internal structure of the coil component of the present disclosure;

FIG. 10 is a perspective view schematically showing an example of an internal structure of a coil component including a plurality of coils;

FIG. 11 is a perspective view schematically showing a first modification of the internal structure of the coil component including the plurality of coils; and

FIG. 12 is a perspective view schematically showing a second modification of the internal structure of the coil component including the plurality of coils.

### DETAILED DESCRIPTION

Hereinafter, a coil component of the present disclosure will be described.

However, the present disclosure is not limited to the following embodiment, and can be appropriately modified and applied without changing the gist of the present disclosure. The present disclosure also includes a combination of two or more of individual desirable configurations of the present disclosure described below.

In the present specification, the terms indicating the relationship between elements (for example, “parallel”, “vertical”, “orthogonal”, and the like) and the terms indicating the shape of an element are not expressions indicating only a strict meaning, but are expressions meaning to include a substantially equivalent range, for example, a difference of about several %.

The drawings shown below are schematic views, and dimensions, scales of aspect ratios, and the like may be different from those of actual products.

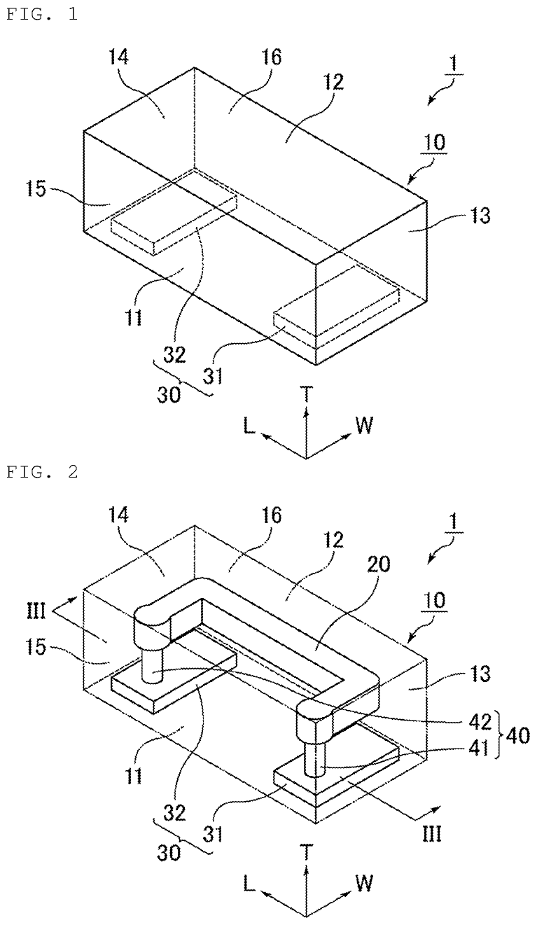

FIG. 1 is a perspective view schematically showing an example of the coil component of the present disclosure. FIG. 2 is a perspective view schematically showing an example of an internal structure of the coil component shown in FIG. 1. The shape, arrangement, and the like of the coil component and each component are not limited to the shown example.

The coil component 1 shown in FIGS. 1 and 2 includes a magnetic body 10, a coil 20, an external electrode 30, and an extended conductor 40.

The magnetic body 10 has, for example, a substantially rectangular parallelepiped shape having six surfaces. The magnetic body 10 may have corner portions and ridge portions rounded. The corner portion is a portion where the three surfaces of the magnetic body 10 intersect, and the ridge portion is a portion where the two surfaces of the magnetic body 10 intersect.

In FIGS. 1 and 2, the length direction, the width direction, and the height direction of the coil component 1 and the magnetic body 10 are indicated as an L direction, a W direction, and a T direction, respectively. The length direction L, the width direction W, and the height direction T are orthogonal to each other. The mounting surface of the coil component 1 is, for example, a surface (LW surface) parallel to the length direction L and the width direction W.

The magnetic body 10 shown in FIGS. 1 and 2 includes a first main surface 11 and a second main surface 12 facing each other in the height direction T, a first end surface 13 and a second end surface 14 facing each other in the length direction L orthogonal to the height direction T, and a first side surface 15 and a second side surface 16 facing each other in the width direction W orthogonal to the length direction L and the height direction T. In the example shown in FIGS. 1 and 2, the first main surface 11 of the magnetic body 10 corresponds to the bottom surface of the magnetic body 10.

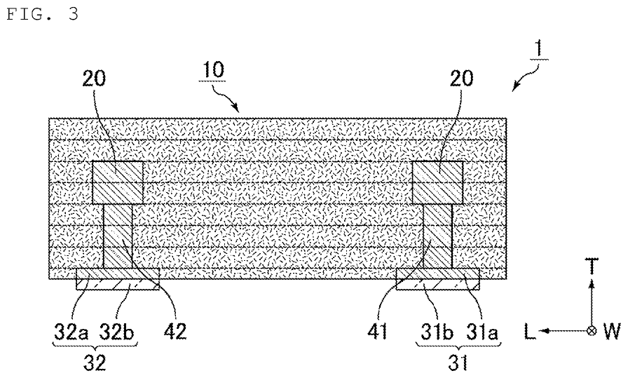

FIG. 3 is a sectional view of the coil component shown in FIG. 2 taken along line III-III.

As shown in FIG. 3, the magnetic body 10 preferably has a laminated structure. In the example shown in FIG. 3, the lamination direction of the magnetic body 10 is along the height direction T. Note that, in FIG. 3, for convenience of explanation, a boundary of each layer of the laminated structure of the magnetic body 10 is shown, but in practice, the boundary does not appear clearly.

When the magnetic body 10 has a laminated structure, the degree of freedom in designing the coil component 1 increases. For example, in the case of manufacturing the coil component 1 including the external electrode 30 on the bottom surface (first main surface 11) of the magnetic body 10, when the magnetic body 10 has a laminated structure, it is easy to extend the coil 20 to the bottom surface side.

The magnetic body 10 contains, for example, a magnetic material such as metal magnetic particles.

Examples of the metal magnetic material constituting the metal magnetic particles include alloys containing Fe and Si such as an Fe—Si alloy and an Fe—Si—Cr alloy. These alloys may contain elements such as Cr, Mn, Cu, Ni, P, and S as impurities.

An insulating film may be provided on the surface of the metal magnetic particle. In this case, since the insulation property of the magnetic body 10 is improved, the withstand voltage of the coil component 1 can be further improved. The insulating film is preferably an oxide film containing a metal oxide, and more preferably an oxide film containing an oxide of Si.

The magnetic body 10 may further contain a component other than the metal magnetic particles. For example, the magnetic body 10 may contain an element such as Cr, Al, Li, or Zn as an element that is more easily oxidized than Fe.

The magnetic body 10 may further contain a resin. When the magnetic body 10 contains a resin, the type of the resin is not particularly limited, and can be appropriately selected according to desired characteristics. The magnetic body 10 may contain, for example, one or more resins selected from the group consisting of an epoxy resin, a phenol resin, a polyester resin, a polyimide resin, a polyolefin resin, a silicone resin, an acrylic resin, a polyvinyl butyral resin, a cellulose resin, an alkyd resin, and the like.

The coil 20 is embedded in the magnetic body 10. As shown in FIGS. 2 and 3, the coil 20 is present only on one plane including the start end and the terminal end. Therefore, the start end and the terminal end of the coil 20 are present on the same plane. When the bottom surface (first main surface 11) of the magnetic body 10 is taken as a reference, the position of the start end of the coil 20 in the height direction T is preferably the same as the position of the terminal end of the coil 20 in the height direction T.

The coil 20 preferably is present only on one plane including the start end and the terminal end. For example, the surface on which the coil 20 is present is a plane parallel to the bottom surface (first main surface 11) of the magnetic body 10.

As long as the coil 20 is present on only one plane, the coil 20 may include a plurality of laminated coil conductor layers, as shown in FIG. 3. Note that, in FIG. 3, for convenience of explanation, a boundary of each layer of the coil conductor layer is shown, but in practice, the boundary does not appear clearly.

The external electrode 30 is provided on at least the bottom surface (first main surface 11) of the magnetic body 10, and is electrically connected to the coil 20. In the coil component 1, the bottom surface (first main surface 11) of the magnetic body 10 can be a mounting surface. That is, mounting on the bottom surface of the coil component 1 becomes possible.

The external electrode 30 includes a first external electrode 31 and a second external electrode 32.

The first external electrode 31 is arranged so as to cover a part of the first main surface 11 of the magnetic body 10. Although not shown in FIG. 1 and the like, the first external electrode 31 may be arranged so as to extend from the first main surface 11 of the magnetic body 10 and cover a part of the first end surface 13, a part of the first side surface 15, or a part of the second side surface 16.

The second external electrode 32 is arranged so as to cover a part of the first main surface 11 of the magnetic body 10. Although not shown in FIG. 1 and the like, the second external electrode 32 may be arranged so as to extend from the first main surface 11 of the magnetic body 10 and cover a part of the second end surface 14, a part of the first side surface 15, or a part of the second side surface 16.

The external electrode 30 includes, for example, a base layer and a plating layer in order from the magnetic body 10 side. In the example shown in FIG. 3, the first external electrode 31 includes a base layer 31a and a plating layer 31b in order from the magnetic body 10 side, and the second external electrode 32 includes a base layer 32a and a plating layer 32b in order from the magnetic body 10 side.

The base layer of the external electrode 30 is, for example, a base electrode containing Ag.

The plating layer of the external electrode 30 is provided so as to cover the base layer. The plating layer may be one layer or two or more layers.

As shown in FIGS. 2 and 3, both ends of the coil 20 are extended to the bottom surface (first main surface 11) of the magnetic body 10. Specifically, the coil 20 is electrically connected to the external electrode 30 with the extended conductor 40 interposed therebetween at the bottom surface (first main surface 11) of the magnetic body 10.

One end of the extended conductor 40 is connected to the coil 20 inside the magnetic body 10. The other end of the extended conductor 40 is connected to the external electrode 30 at the bottom surface (first main surface 11) of the magnetic body 10.

The extended conductor 40 includes a first extended conductor 41 and a second extended conductor 42.

One end of the first extended conductor 41 is connected to the start end of the coil 20. The other end of the first extended conductor 41 is connected to the first external electrode 31. In the example shown in FIGS. 2 and 3, the direction extending from one end to the other end of the first extended conductor 41 is along the height direction T.

As shown in FIG. 3, the first extended conductor 41 may have a laminated structure. In the example shown in FIG. 3, the lamination direction of the first extended conductor 41 is along the height direction T. Note that, in FIG. 3, for convenience of explanation, a boundary of each layer of the laminated structure of the first extended conductor 41 is shown, but in practice, the boundary does not appear clearly.

One end of the second extended conductor 42 is connected to the terminal end of the coil 20. The other end of the second extended conductor 42 is connected to the second external electrode 32. In the example shown in FIGS. 2 and 3, the direction extending from one end to the other end of the second extended conductor 42 is along the height direction T.

As shown in FIG. 3, the second extended conductor 42 may have a laminated structure. In the example shown in FIG. 3, the lamination direction of the second extended conductor 42 is along the height direction T. Note that, in FIG. 3, for convenience of description, a boundary of each layer of the laminated structure of the second extended conductor 42 is shown, but the boundary does not appear clearly in practice.

In the coil component 1, in addition to the fact that the coil 20 is present only on one plane including the start end and the terminal end, when a surface on which the coil 20 is present is viewed from a direction (height direction T) extending from one end to the other end of the first extended conductor 41, the coil 20 and the first extended conductor 41 do not overlap each other except for a portion where the coil 20 and the first extended conductor 41 are connected, and when the surface on which the coil 20 is present is viewed from the direction (height direction T) extending from one end to the other end of the second extended conductor 42, the coil 20 and the second extended conductor 42 do not overlap each other except for a portion where the coil 20 and the second extended conductor 42 are connected.

In the coil component 1, the coil 20 present only on one plane is electrically connected to the external electrode 30 on the bottom surface (first main surface 11) of the magnetic body 10 with the extended conductor 40 interposed therebetween, so that it is possible to acquire a small size, a low height, and a low inductance. In addition, unlike a conventional structure in which a coil is wound over a plurality of layers, DC resistance is reduced, so that it is possible to cope with a large current. Furthermore, since the coil and the extended conductor 40 do not overlap each other except for the portion where the coil 20 and the extended conductor 40 are connected, the risk of a short circuit can also be reduced.

The first extended conductor 41 preferably does not protrude from the first external electrode 31 when the surface on which the coil 20 is present is viewed from the direction (height direction T) extending from one end to the other end of the first extended conductor 41. Similarly, when the surface on which the coil 20 is present is viewed from the direction (height direction T) extending from one end to the other end of the second extended conductor 42, the second extended conductor 42 preferably does not protrude from the second external electrode 32. As a result, the connection distance between the coil 20 and the external electrode 30 can be shortened, so that the DC resistance is further reduced.

The length from one end to the other end of the first extended conductor 41 is preferably the same as the length from one end to the other end of the second extended conductor 42. As a result, the connection distance between the coil 20 and the external electrode 30 can be shortened, so that the DC resistance is further reduced.

In particular, the length from one end to the other end of the first extended conductor 41 is preferably the same as the length from one end to the other end of the second extended conductor 42, and the sectional area perpendicular to the direction (height direction T) extending from one end to the other end of the first extended conductor 41 is preferably the same as the sectional area perpendicular to the direction (height direction T) extending from one end to the other end of the second extended conductor 42. In this case, by making the density of current flowing through the extended conductor 40 the same, it is possible to reduce unevenness of heat generation due to current application.

The sectional shape perpendicular to the direction (height direction T) extending from one end to the other end of the first extended conductor 41 is not particularly limited, and examples thereof include a polygon such as a quadrangle, a circle, and an ellipse.

The shape of the coil 20 at the portion connected to the first extended conductor 41 is not particularly limited, and can be arbitrarily changed in accordance with the sectional shape of the first extended conductor 41.

The sectional shape perpendicular to the direction (height direction T) extending from one end to the other end of the second extended conductor 42 is not particularly limited, and examples thereof include a polygon such as a quadrangle, a circle, and an ellipse. The sectional shape of the second extended conductor 42 may be different from the sectional shape of the first extended conductor 41, but is preferably the same.

The shape of the coil 20 at the portion connected to the second extended conductor 42 is not particularly limited, and can be arbitrarily changed in accordance with the sectional shape of the second extended conductor 42. The shape of the coil 20 at the portion connected to the second extended conductor 42 may be different from the shape of the coil 20 at the portion connected to the first extended conductor 41, but is preferably the same.

Although not shown, the coil component 1 may further include an insulating layer. For example, an insulating layer may be provided at a position overlapping the coil 20 when viewed from the height direction T.

The material constituting the insulating layer is not particularly limited as long as it is a material having higher insulating property than the magnetic body 10, and examples thereof include a nonmagnetic material, a ferrite material, and a metal magnetic material.

The coil component of the present disclosure is manufactured, for example, by the following method.

Hereinafter, an example of a method for manufacturing the coil component 1 using a printing lamination method will be described. The coil component of the present disclosure may be manufactured using a printing lamination method or may be manufactured using a sheet lamination method.

First, a magnetic paste is prepared.

For example, a metal magnetic powder such as an Fe—Si alloy or an Fe—Si—Cr alloy having a volume-based cumulative 50% particle diameter D50 of 2 μm or more and 20 μm or less (i.e., from 2 μm to 20 μm) (preferably about 10 μm) is prepared. A binder such as cellulose or polyvinyl butyral (PVB) and a solvent such as terpineol or butyl diglycol acetate (BCA) are contained in a metal magnetic powder and kneaded to prepare a magnetic paste containing metal magnetic particles.

When an Fe—Si alloy is used as the metal magnetic powder, the content of Si is preferably 2.0 at % or more and 8.0 at % or less (i.e., from 2.0 at % to 8.0 at %). When an Fe—Si—Cr alloy is used as the metal magnetic powder, the content of Si is preferably 2.0 at % or more and 8.0 at % or less (i.e., from 2.0 at % to 8.0 at %), and the content of Cr is preferably 0.2 at % or more and 6.0 at % or less (i.e., from 0.2 at % to 6.0 at %).

An insulating film may be provided on the surface of the metal magnetic powder. The insulating film is preferably an oxide film containing a metal oxide, and more preferably an oxide film containing an oxide of Si. Examples of the method for forming the insulating film include a mechanochemical method and a sol-gel method. Among them, a sol-gel method is preferable. When an oxide film containing an oxide of Si is formed by a sol-gel method, for example, the oxide film can be formed by mixing a sol-gel coating agent containing a Si alkoxide and an organic chain-containing silane coupling agent, attaching this mixed liquid to the surface of a metal magnetic powder, dehydrating and bonding the metal magnetic powder by a heat treatment, and then drying the metal magnetic powder at a predetermined temperature.

Separately, a conductive paste is prepared. For example, a conductive paste containing Ag is prepared.

A laminate block is prepared using the magnetic paste and the conductive paste.

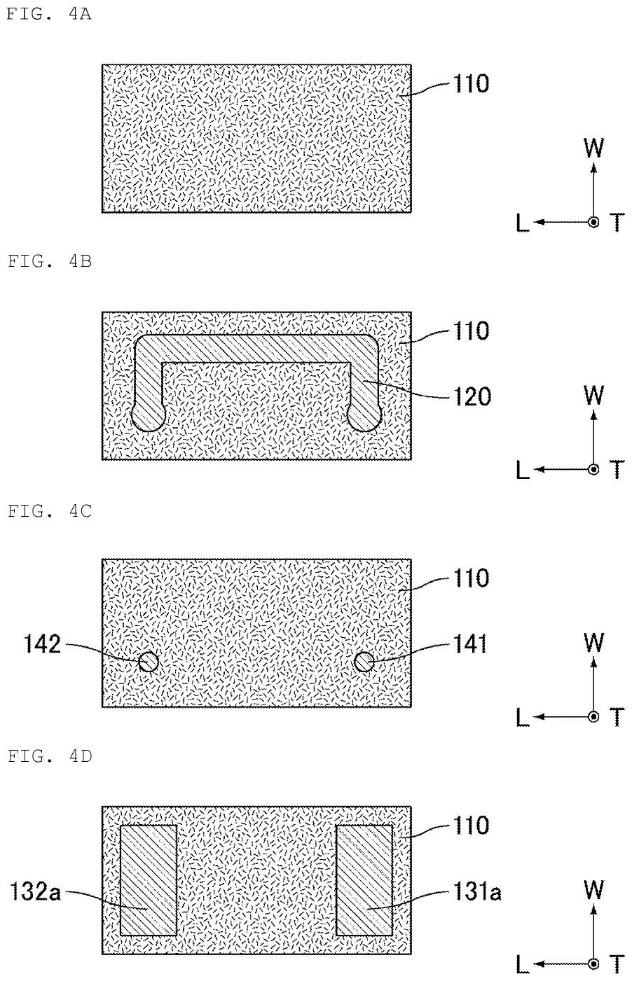

FIG. 4A is a plan view schematically showing an example of a method for forming a magnetic paste layer.

Although not shown, first, a substrate in which a thermal release sheet and a PET (polyethylene terephthalate) film are stacked on a metal plate is prepared. The magnetic paste is screen-printed a predetermined number of times on the substrate to form the magnetic paste layer 110. This becomes an outer layer of the coil component.

FIG. 4B is a plan view schematically showing an example of a method for forming a conductive paste layer on a magnetic paste layer.

A conductive paste is printed on the magnetic paste layer 110 to form a conductive paste layer 120 as a coil conductor layer of the coil 20. Further, the magnetic paste layer 110 is formed in a region where the conductive paste layer 120 is not formed. This is repeated a predetermined number of times. The conductive paste layer 120 and the magnetic paste layer 110 may be formed so that parts thereof overlap each other at a boundary portion.

FIG. 4C is a plan view schematically showing an example of a method for forming a via conductor on a conductive paste layer.

A conductive paste is printed on the conductive paste layer 120 to form via conductors 141 and 142 to be extended to the bottom surface. Furthermore, a magnetic paste is printed on a region where the via conductors 141 and 142 are not formed to form the magnetic paste layer 110. This is repeated a predetermined number of times.

FIG. 4D is a plan view schematically showing an example of a method for forming a conductive paste layer as a base layer of an external electrode.

Finally, a conductive paste layer as a base layer of the external electrode 30 is formed. Specifically, a conductive paste layer 131a as the base layer 31a of the first external electrode 31 and a conductive paste layer 132a as the base layer 32a of the second external electrode 32 are formed. Further, the magnetic paste layer 110 is formed in a region where the conductive paste layers 131a and 132a are not formed.

The laminate produced by the above procedure is pressurized and compressed to obtain a laminate block.

An element is obtained by cutting the laminate block with a dicer or the like to singulate the laminate block. The laminate block may be singulated after firing.

After degreasing the singulated element, the element is put in a firing furnace and fired under the conditions of 600° C. or more and 800° C. or less (i.e., from 600° C. to 800° C.), and 30 minutes or more and 90 minutes or less (i.e., from 30 minutes to 90 minutes) in the air.

If necessary, a resin such as an epoxy resin is impregnated and thermally cured. By impregnating the metal magnetic particles with the resin, voids between the metal magnetic particles are filled with the resin, so that the strength of the magnetic body 10 can be secured, and ingress of a plating solution, moisture, or the like can be suppressed.

A plating layer is formed on the base layer by electrolytic plating. As the plating layer, for example, a Cu coating may be formed, a Ni coating and a Cu coating may be formed in order, a Ni coating and a Sn coating may be formed in order, or a Ni coating and an Au coating may be formed in order. Thus, the external electrode 30 is formed.

As described above, the coil component 1 as shown in FIG. 1 can be manufactured. The size of the coil component 1 is, for example, 4.0 mm in the length direction L, 1.2 mm in the width direction W, and 0.4 mm or more and 1.0 mm or less (i.e., from 0.4 mm to 1.0 mm) (for example, 0.64 mm) in the height direction T, and the thickness of the coil 20 (the total thickness of the coil conductor layers) is 90 μm.

The ratio of the thickness of the coil 20 to the thickness of the magnetic body 10 is preferably 0.01 or more and 0.4 or less (i.e., from 0.01 to 0.4), and more preferably 0.05 or more and 0.3 or less (i.e., from 0.05 to 0.3). In this case, the height of the coil component 1 can be reduced.

In the above example, the coil 20 and the external electrode 30 are formed using the same conductive paste, but the coil 20 and the external electrode 30 may be formed using different conductive pastes.

The coil component of the present disclosure is not limited to the above embodiment, and various applications and modifications can be made within the scope of the present disclosure regarding the configuration, manufacturing conditions, and the like of the coil component.

In the coil component 1 shown in FIGS. 1 and 2, the pattern shape of the coil 20 is a C-shape (U-shape) bent at two positions, but the pattern shape of the coil 20 is not particularly limited. The inductance can be adjusted by changing the pattern shape of the coil 20. The pattern shape of the coil 20 is preferably a symmetrical shape such as line symmetry or point symmetry.

FIG. 5 is a perspective view schematically showing a first modification of the internal structure of the coil component of the present disclosure.

In a coil component 1A shown in FIG. 5, a coil 20 has an M-shaped pattern shape bent at three positions. The pattern shape of the coil 20 is line symmetric.

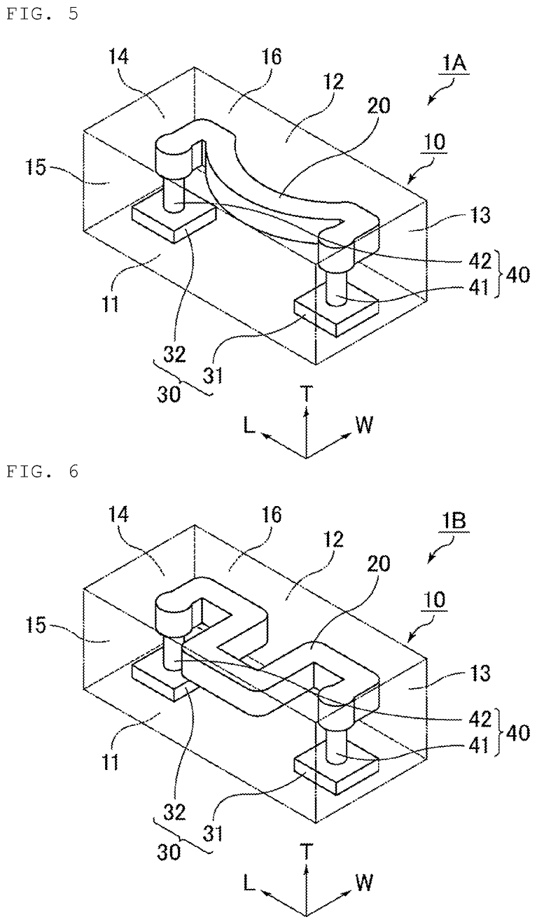

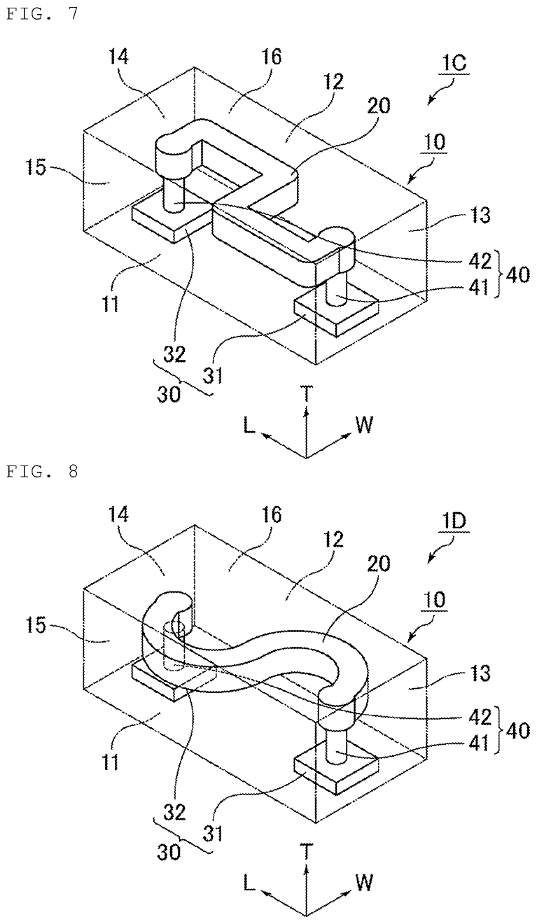

FIG. 6 is a perspective view schematically showing a second modification of the internal structure of the coil component of the present disclosure.

In a coil component 1B shown in FIG. 6, a coil 20 has a pattern shape bent at six positions. The pattern shape of the coil 20 is line symmetric.

FIG. 7 is a perspective view schematically showing a third modification of the internal structure of the coil component of the present disclosure.

In a coil component 1C shown in FIG. 7, a coil 20 has an inverted S-shaped pattern shape bent at four positions. The pattern shape of the coil 20 is point symmetric.

FIG. 8 is a perspective view schematically showing a fourth modification of the internal structure of the coil component of the present disclosure.

In a coil component 1D shown in FIG. 8, a coil 20 has an S-shaped pattern shape. The pattern shape of the coil 20 is point symmetric.

FIG. 9 is a perspective view schematically showing a fifth modification of the internal structure of the coil component of the present disclosure.

In a coil component 1E shown in FIG. 9, a coil 20 has a linear pattern shape. The pattern shape of the coil 20 is line symmetric and point symmetric.

One coil 20 may be arranged or a plurality of coils 20 may be arranged inside the magnetic body 10. By arranging the plurality of coils 20 inside the magnetic body 10, it is possible to reduce the mounting area of coil components and the number of mounting coil components.

When the plurality of coils 20 are arranged inside the magnetic body 10, the configurations of the coils 20 may be the same or parts thereof may be different.

When the plurality of coils 20 are arranged inside the magnetic body 10, the arrangement of the coils 20 is not particularly limited. The plurality of coils 20 may all be arranged in the same direction, or some may be arranged in different directions. The plurality of coils 20 may be linearly arranged or may be arranged in a planar shape. The plurality of coils 20 may be arranged regularly or irregularly.

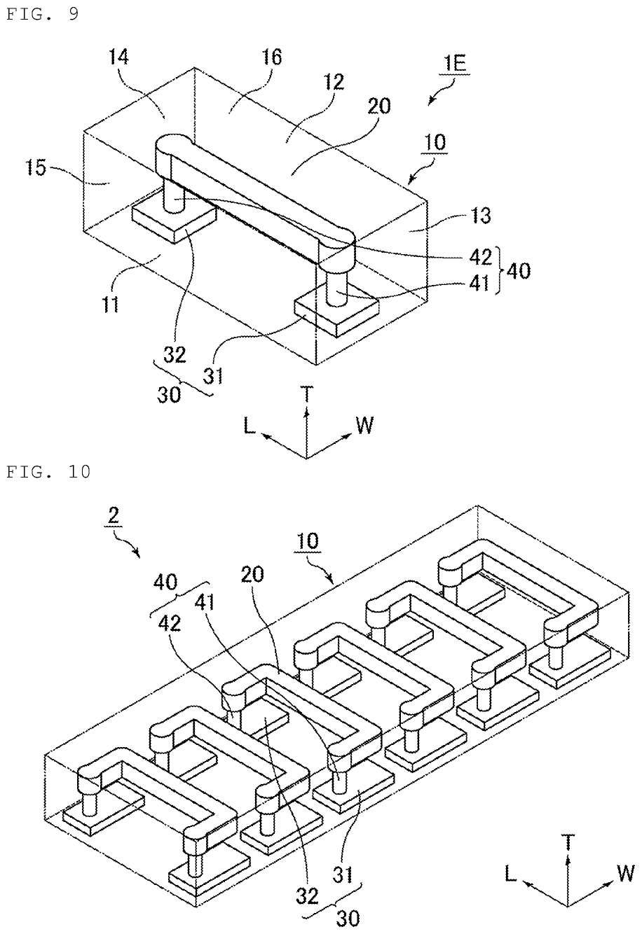

FIG. 10 is a perspective view schematically showing an example of an internal structure of a coil component including a plurality of coils.

In a coil component 2 shown in FIG. 10, six coils 20 are linearly arranged inside the magnetic body 10. The six coils 20 are all arranged in the same direction.

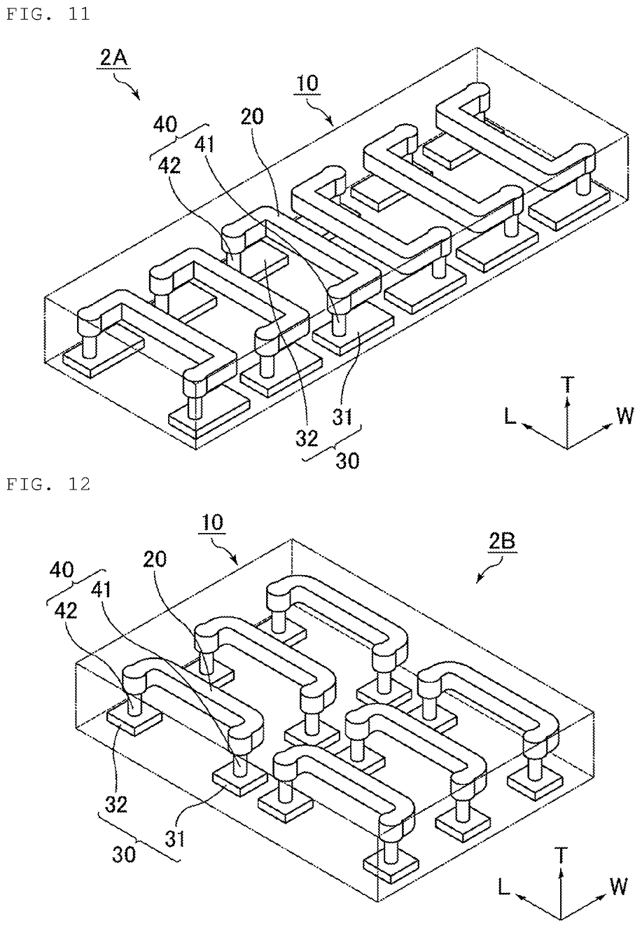

FIG. 11 is a perspective view schematically showing a first modification of the internal structure of the coil component including the plurality of coils.

In a coil component 2A shown in FIG. 11, six coils 20 are linearly arranged inside the magnetic body 10. Three pattern shapes of the six coils 20 are arranged symmetrically. As described above, when the pattern shapes of the coils 20 are arranged symmetrically, variations in inductance between the coils 20 can be suppressed.

FIG. 12 is a perspective view schematically showing a second modification of the internal structure of the coil component including the plurality of coils.

In a coil component 2B shown in FIG. 12, six coils 20 are arranged in a planar shape inside the magnetic body 10. The six coils 20 are all arranged in the same direction. In the example shown in FIG. 12, two coils 20 are arranged in the length direction L and three coils 20 are arranged in the width direction W. However, for example, three coils 20 may be arranged in the length direction L and two coils 20 may be arranged in the width direction W.

What is claimed is:

1. A coil component comprising:
a magnetic body;
a coil embedded in the magnetic body;
an external electrode on at least a bottom surface of the magnetic body and electrically connected to the coil; and
an extended conductor in which one end is connected to the coil inside the magnetic body and an other end is connected to the external electrode on the bottom surface of the magnetic body,
the external electrode including a first external electrode and a second external electrode,
the extended conductor including a first extended conductor having one end connected to a start end of the coil and an other end connected to the first external electrode, and a second extended conductor having one end connected to a terminal end of the coil and an other end connected to the second external electrode,
the coil being present only on a plane including the start end and the terminal end,
the coil and the first extended conductor not overlapping each other except for a portion where the coil and the first extended conductor are connected, when a surface on which the coil is present is viewed from a direction extending from the one end to the other end of the first extended conductor, and
the coil and the second extended conductor not overlapping each other except for a portion where the coil and the second extended conductor are connected, when the surface on which the coil is present is viewed from a direction extending from the one end to the other end of the second extended conductor.

2. The coil component according to claim 1, wherein
when the surface on which the coil is present is viewed from the direction extending from the one end to the other end of the first extended conductor, the first extended conductor is within an area of the first external electrode, and
when the surface on which the coil is present is viewed from the direction extending from the one end to the other end of the second extended conductor, the second extended conductor is within an area of the second external electrode.

3. The coil component according to claim 1, wherein
a length from the one end to the other end of the first extended conductor is the same as a length from the one end to the other end of the second extended conductor.

4. The coil component according to claim 3, wherein
a cross sectional area of the first extended conductor perpendicular to the direction extending from the one end to the other end of the first extended conductor is the same as a cross sectional area of the second extended conductor perpendicular to the direction extending from the one end to the other end of the second extended conductor.

5. The coil component according to claim 1, wherein
the coil includes a plurality of coils which are inside the magnetic body.

6. The coil component according to claim 2, wherein
a length from the one end to the other end of the first extended conductor is the same as a length from the one end to the other end of the second extended conductor.

7. The coil component according to claim 6, wherein
a cross sectional area of the first extended conductor perpendicular to the direction extending from the one end to the other end of the first extended conductor is the same as a cross sectional area of the second extended conductor perpendicular to the direction extending from the one end to the other end of the second extended conductor.

8. The coil component according to claim 2, wherein
the coil includes a plurality of coils which are inside the magnetic body.

9. The coil component according to claim 3, wherein
the coil includes a plurality of coils which are inside the magnetic body.

10. The coil component according to claim 4, wherein
the coil includes a plurality of coils which are inside the magnetic body.

11. The coil component according to claim 6, wherein
the coil includes a plurality of coils which are inside the magnetic body.

12. The coil component according to claim 7, wherein
the coil includes a plurality of coils which are inside the magnetic body.
